(19) United States
(12) Patent Application Publication
(10) Pub. No.: US 2013/0208729 A1
(43) Pub. Date: Aug. 15, 2013

(54) SYSTEMS AND METHODS FOR FACILITATION OF COMMUNICATIONS SESSIONS AMONGST A PLURALITY OF NETWORKS

(71) Applicant: Neutral Tandem, Inc. d/b/a Inteliquent, (US)

(72) Inventors: G. Edward Evans, Oklahoma City, OK (US); Ian Neale, Winnetka, IL (US); Jack Hwang, Greenwood Village, CO (US)

(73) Assignee: NEUTRAL TANDEM, INC. D/B/A INTELIQUENT, Chicago, IL (US)

(21) Appl. No.: 13/767,696

(22) Filed: Feb. 14, 2013

Related U.S. Application Data
(60) Provisional application No. 61/598,581, filed on Feb. 14, 2012.

(51) Int. Cl. H04L 12/66

(52) U.S. Cl. CPC H04L 12/66
USPC 370/401

(57) ABSTRACT

Systems and methods that allow carriers, content providers and other stakeholders to, among other things, efficiently manage communications sessions, such as delivery of content, across one or more of a plurality of networks.

### PRIORITY CLAIM

This is a non-provisional application claiming priority to, and the benefit of, U.S. Provisional Patent Application No. 61/598,581, filed on Feb. 14, 2012, the entire contents of which is incorporated by reference herein.

### TECHNICAL FIELD

This disclosure relates to the field of telecommunications, and more particularly, to communications sessions across disparate networks.

### BACKGROUND

Telecommunications carriers, intercarrier providers, content providers, retail services providers, and other stakeholders (sometimes collectively referred to herein as carriers or service providers) currently face many challenges to efficiently manage communications sessions across disparate networks. Wireless service providers, for example, face tremendous challenges in dealing with data traffic destined for wireless devices, such as smart phones and other devices, within wireless networks. Existing network architecture does not give service providers the ability to adequately protect consumers from fraudulent traffic and lacks the ability to provision the network for the specific type of content traffic being delivered to a device, which, among other things, causes network inefficiencies and quality of service (QoS) challenges within the networks. Existing network architecture is also structured such that economic settlement amongst carriers and service and content providers is a difficult task, resulting in lost revenues.

The invention(s) described herein is/are directed, but not limited, to addressing these and other issues associated with existing systems and methods. Other aspects and benefits not related to these issues are contemplated as well.

### SUMMARY

According to a particular aspect, a system for facilitating a communications session between an originating network and a device within a terminating network amongst a plurality of networks is provided. The system includes a gateway capable of communicating with the plurality of networks, including the originating network and the terminating network. The system also includes a registry in communication with the gateway and having access to device data, including identification and location data, for a plurality of devices within the plurality of networks, including the device within the terminating network. The gateway is configured to receive a request from the originating network, access the registry for the device data for the device, and one of either send data based on at least a portion of the device data to the originating network to allow the originating network to establish the communications session with the device within the terminating network, or establish the communications session with the device within the terminating network on behalf of the originating network.

According to yet another particular aspect, a system for facilitating delivery of content from an originating network to a device within a terminating network amongst a plurality of networks is provided. The system includes a gateway capable of communicating with the plurality of networks, including the originating network and the terminating network. The system also includes a registry in communication with the gateway and having access to device data, including identification and location data, for a plurality of devices within the plurality of networks, including the device within the terminating network. The gateway is configured to receive a request associated with the content from the originating network, access the registry for device data for the device, and either send data based on at least a portion of the device data to the originating network to allow the originating network to deliver the content to the terminating network or otherwise treat the request, or deliver the content to the terminating network or otherwise treat the request on behalf of the originating network.

According to another particular aspect, a system for facilitating a communications session between a device within an originating network and a device within a terminating network amongst a plurality of networks is provided. The system includes a gateway capable of communicating with the plurality of networks, including the originating network and the terminating network. The system also includes a registry in communication with the gateway and having access to device data, including identification and location data, for a plurality of devices within the plurality of networks, including the device within the originating network and the device within the terminating network. The gateway is configured to receive a request for a communications session from the originating network, access the registry for device data, and perform one of the following: (1) send data based on the device data to the originating network to allow the originating network to establish the communications session with the device or otherwise treat the request for the communications session within the originating network; (2) establish the communications session with the device within the terminating network; or (3) otherwise treat the request for the communications session on behalf of the originating network.

According to other aspects, systems and methods are provided that allow carriers, content providers and other stakeholders to, among other things, efficiently manage communications sessions, such as, for example, data traffic or content delivery across a plurality of networks, including, but not limited to disparate wireless networks, or within a single network. A particular application is directed to efficiently managing communications sessions between networks, the types of which may include without limitation SMS or SMS like messages, MMS messages, video calls, video streams, VoIP voice calls, HD VoIP voice calls, VoLTE voice calls, HD VoLTE voice calls, application push notifications, presence, and types of the like. Other aspects are directed to increasing security of the contemplated networks by leveraging authentication techniques associated with data delivery from within an originating network to one or more devices within a terminating network. Yet other aspects are directed to providing data associated with the communication session, such as content type or user preference, to an originating network and/or terminating network to facilitate provisioning for the communication session, such as provisioning based on the content type or user preference. Yet other aspects are directed to providing business rules and financial clearing and reporting functions to a plurality of networks utilizing systems and methods contemplated herein.

These and other aspects will become readily apparent from the written specification, drawings, and claims provided herein.

### BRIEF DESCRIPTION OF DRAWINGS

FIG. 1 is a schematic diagram of an exemplary system and associated functionality in accordance with one or more aspects described herein.

FIG. 2 is a flow chart of an exemplary method according to one or more aspects described herein.

FIG. 3 is a schematic diagram of an exemplary system and associated networks in accordance with one or more aspects described herein.

FIG. 4 is a schematic diagram of an exemplary system and associated functionality in accordance with one or more aspects described herein.

### DETAILED DESCRIPTION OF EXEMPLARY EMBODIMENTS

The description that follows describes, illustrates and exemplifies one or more particular embodiments of the invention(s) in accordance with its principles. This description is not provided to limit the invention(s) to the embodiments described herein, but rather to explain and teach the principles of the invention(s) in such a way to enable one of ordinary skill in the art to understand these principles and, with that understanding, be able to apply them to practice not only the embodiments described herein, but also other embodiments that may come to mind in accordance with these principles. The scope of the invention(s) is/are intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates the didactic purpose of the specification. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the invention(s) as taught herein and understood to one of ordinary skill in the art.

With respect to the exemplary systems, components and architecture described and illustrated herein, it should also be understood that the invention(s) may be embodied by, or employed in, numerous configurations and components, including one or more system, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system. Furthermore, although one or more systems and associated gateways, registries and databases will be described, all methods, systems, and articles of manufacture consistent with known architecture for these components are intended to be encompassed. For example, a processor may be implemented as part of one or more components as a microprocessor, microcontroller, application specific integrated circuit (ASIC), discrete logic, or a combination of other type of circuits or logic. Similarly, memories as part of one or more of these components may be DRAM, SRAM, Flash or any other type of memory. Flags, data, databases, tables, and other data structures may be separately stored and managed, may be incorporated into a single memory or database, may be distributed, or may be logically and physically organized in many different ways. Software programs may be parts of a single program, separate programs, or distributed across several memories and processors. The methods and functionality described herein may be implemented via hardware, software, and/or firmware, and processed by one or more processor-based systems, components or devices. Such methods and functionality may be described as a module or engine with the understanding that its implementation is not limited to any particular hardware, software, firmware, or device configuration, but rather encompassing all implementations/embodiments within the skill of one of ordinary skill in the art. Systems may be implemented in hardware, software, or a combination of hardware and software in one processing system or distributed across multiple processing systems. Accordingly, the invention(s) should not be construed as limited by the exemplary embodiments described herein or any of the associated didactic schematics.

The network solutions contemplated and described herein, and realized through systems that will be described herein, allow carriers, content providers and other stakeholders to, among other things, efficiently manage communications sessions across a plurality of networks, including, but not limited to, within a single network or between disparate wireless networks, without discrimination. Communications sessions may involve without limitation SMS or SMS like messages, MMS messages, video calls, video streams, VoIP voice calls, HD VoIP voice calls, VoLTE voice calls, HD, VoLTE voice calls, VoW-Fi voice calls, application push notifications, and the like. A particular application of the system is directed to efficiently managing content delivery between networks. Particular aspects described herein are directed to increasing security of the contemplated networks by leveraging authentication techniques associated with data delivery from within an originating network to one or more devices within a terminating network. Other aspects described herein are directed to providing data associated with the communication session, such as, for example, the type of communications session, or in the case of directed content, the type of content, to an originating network, and/or optionally to a termination network and/or one or more intermediate networks, to facilitate provisioning of the communication session. In the case of content delivery, provisioning may be based on, for example, the content type, which may be determined, for example, by class of service markings, shallow packet inspection, deep packet inspection, or content signature analysis. In other embodiments, the data may include preference data or profile data, which may be associated with the device(s), subscriber(s), or carrier(s). Yet other aspects are directed to providing business rules and financial clearing and reporting functions to a plurality of networks utilizing a system in accordance with the principles of the invention(s).

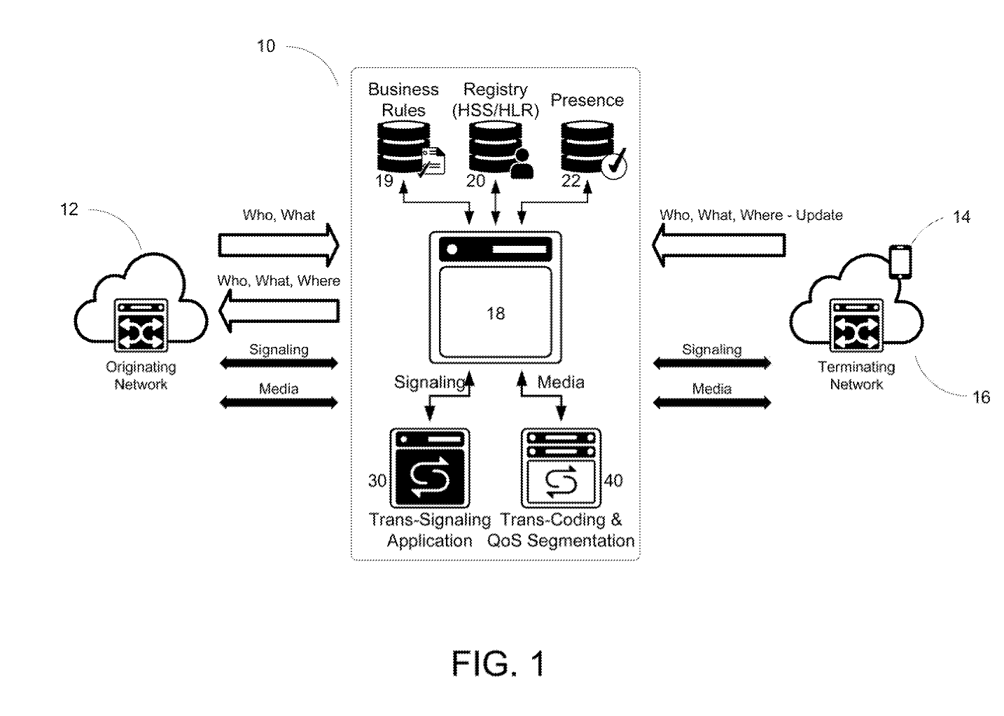

FIG. 1 is a schematic diagram illustrating system components and associated functional aspects of an exemplary embodiment in accordance with one or more principles of the invention(s). At the outset, it should be noted that while many of the embodiments described herein are directed to content delivery, the systems and methods described herein are not limited to such, and have broad application to numerous communications session types, including without limitation, SMS or SMS like messages, MMS messages, video calls, video streams, VoIP voice calls, HD VoIP voice calls, VoLTE voice calls, HD VoLTE voice calls, application push notifications, and the like. Referring generally to FIG. 1, an exemplary system 10 for facilitating a communications session, such as, for example, delivery of content, from an originating device 11 of an originating network 12 to a device 14 within a terminating network 16 is illustrated. The system includes a gateway 18 capable of communicating with the originating network 12 and the terminating network 16 and the devices 11, 14 thereof. The system 10 may be implemented amongst a plurality of networks to facilitate communications sessions with devices amongst the plurality of networks, such as content delivery to the devices. As further discussed herein, various administrative procedures and business rules may be established amongst the plurality of networks that govern, among other things, the business and financial relationships between the networks' associated providers or carriers that utilize the system for these communications sessions. This aspect is illustrated in FIG. 1 as the business rules module or engine 19.

The system includes a registry 20 that is in communication with the gateway 18. The registry 20 may comprise a single database or registry, or a set of registries and/or database services to provide or otherwise access a database having stored therein data utilized to facilitate communications sessions and may include data associated with devices, content providers, carriers or other network or service providers. In some embodiments, the registry 20 may comprise a Home Subscriber Server (HSS) or User Profile Server Function (UPSF). In an embodiment, the data in the registry 20 includes identification, subscribed services, service consumption preferences and profiles, activity data, and/or location data for a plurality of devices within one or more of a plurality of networks associated with the system 10, including without limitation the device 14 within the terminating network 16. In an embodiment, the data in the registry 20 includes capability data associated with the device 14 and optionally the originating device 11. Identification data, which may be used to locate the device 14, may include without limitation, Directory Number (e.g., Mobile ISDN or Mobile Directory Number), Subscriber Routing Number (e.g., International Mobile Subscriber Identifier, Mobile Identification Number (MIN)), IP address, device MAC address, application user name (e.g., Facebook® user name or GoogleTalk® user name), URI, or other data as requested by content providers, carriers or other system users. Utilizing this data, the registry 20 will associate the device 14 or devices available with which to establish one or more requested communications sessions. In the example of a communication session involving content delivery, the registry 20 will associate the device 14 or devices available to receive the content. Location data may be obtained from carrier HSS or Home Location Registers (HLRs), databases administered by the Number Portability Administration Center (NPAC), or other industry databases, or obtained via a dynamic location-based query to a network associated with the device 14.

As illustrated in FIG. 1, the system 10 may leverage a presence database or other presence source 20, such as via RCS (Rich Communication Suite) or OMA (open mobile alliance) presence capabilities, access to a SIP presence server, or industry standard database dips, such as access to databases administered by NPAC, to determine device presence within a network. Presence data may be incorporated into the registry 20 or separately accessed by the gateway 18 depending on process configuration. Further, the presence data of the presence source 22 can indicate presence states or access methods (e.g., roaming, Wi-Fi connectivity, network connectivity, etc.) associated with the originating device 11 and/or the device 14.

In some embodiments, the system 10 may also leverage capability data of the device 14 and optionally the originating device 11 stored in the registry 20 along with device capability data for a plurality of devices within one or more of a plurality of networks associated with the system 10. Capability data may include without limitation, identity of signal or media types compatible with the devices, identity of applications on the devices, device hardware capability or limitation, or the like. Such data may be used, for example, to identify the need for network provisioning, or transcoding or trans-signaling needs as described herein.

The system 10 may employ multiple data feeds from the NPAC, carrier HSS/HLRs, content provider databases, or other databases to continually update the registry 20. Additionally, the system 10 may pull data from external sources as needed. Carriers and providers participating in the registry 20 may be required to agree to specific industry association designed rules and regulations regarding database security, database update process and procedure, and proper uses of database dips.

As schematically illustrated in FIG. 1, a particular functional aspect of the system 10 is to provide to the originating network 12 the “where” data associated with the communications session, i.e., the location/presence of the device 14 and/or other device(s) (such as the originating device 11) associated with the requested communications session, in response to the “who” data of the communications session, i.e., identification of the device 14, such as ITU-T E.164 number, URI, IP address and the like, and “what” data of the communications session, i.e., device type, services supported, and communication/communication type, based on a request received from the originating device 11. The “where” data is determined by leveraging the registry 20, which as noted is updated by the various data feeds, which include data feeds that rely on updates or dynamically pulled data from the plurality of networks within which the devices are present, including the device 14 within the terminating network 16. This particular aspect is schematically illustrated in FIG. 1 as the “who, what, where—update” arrow feeding back to the system 10. It should be noted that while reference is sometimes made to the device 14, it should be understood that one or more other devices may be associated with the communications session, and reference to the device 14 does not necessarily implicate a single device.

The system 10 can be leveraged by the originating network 12 to provide the appropriate data back to the originating network 12 and the originating device 11 thereof to allow the originating network 12 to facilitate the communications session, such as the delivery of content to the terminating network 16. The system 10 can also be leveraged by the originating network 12 to facilitate the communications session, such as the delivery of content, on behalf of the originating network 12. An exemplary aspect of this second functional configuration is schematically illustrated in FIG. 1 as the “signaling” and “media” arrows, which indicate the delivery of signaling and media data, such as that associated with video content. In particular embodiments, the system 10 may include a trans-signaling engine 30 in communication with the gateway 18 and capable of converting a signal type associated with the communications session to a signal type compatible with the device 14 or client application associated with the device 14 in situations where incompatibility may exist. Other conversions are contemplated as well, including without limitation transport-level interworking such as IPSec to non-IPSec, STCP to TCP, etc. Similarly, the system 10 may include a transcoding engine 40 in communication with the gateway 18 and capable of converting content or code associated with the communications session to make it compatible with the device 14 in situations where incompatibility may exist. Thus, by way of example, the trans-signaling engine 30 and transcoding engine 40 give the system 10 the ability to transcode and trans-signal disparate video signals allowing for “any to any” client video calls or video streaming. For example, a Skype® user attempting to reach a wireless customer reaches the gateway 18 of the system 10. The registry 20 determines that the terminating wireless customer of the device 14 has, for example, a GoogleTalk® client but not the needed Skype® client. In such a case, the system 10 will route the session through the trans-signaling engine 30 and the trans-coding engine 40 and complete the call to the GoogleTalk® client on the wireless customer's device 14. This process is transparent to the end users. Other examples of transcoding may include without limitation HD voice transcoding, SMS to MSRP-type transcoding, or any other transcoding that may be encountered in a communications network environment. In some embodiments, the system 10 may send data to the terminating network 16 as part of a process so that the terminating network 16 may attend to network provisioning based on the communication session directed to the device.

The components and entities of the system 10 can be leveraged to facilitate effective and cost-saving communications among the originating network 12, the terminating network 16, and/or other networks. Although not shown in FIG. 1, the gateway 18 can interface with a web server that a user or entity (e.g., a user of the originating device 11, a user of the terminating device 14, or another user or entity such as a carrier network) can access to set up a profile and specify various rules and parameters associated with receiving and/or sending data communications. In embodiments, the rules and parameters can be associated with the business rules engine 19, the presence source 20, and/or other engines or sources. In an exemplary embodiment, the business rules engine 19 can store or otherwise have access to rules specifying various data communication parameters (e.g., the profile associated with the device 14 or the subscriber associated with the device 14 can only receive 100 SMS messages per day, the device 14 can only receive messages less that 1 MB, etc.). It should be appreciated that the rules and parameters can be set by a user or entity, or can be default values set by an administrator or other entity.

The gateway 18 can interface with the business rules engine 19, the presence source 22, and/or other sources or engines to facilitate data communications. As an example, assume that the originating device 11 attempts to send the terminating device 14 an MMS that exceeds 1 MB, and the terminating device 14 has an associated rule whereby it will only accept a file greater than 1 MB if it is not roaming and/or if it is latched to the data network via Wi-Fi. The originating network 12 can send the message to the gateway 18, which can query the registry 20 for an identification of the terminating device 14 to which the message is to be sent. The gateway 18 can further query the business rules engine 19 with the identification of the terminating device 14 to identify the rule that the device 14 will only accept a file greater than 1 MB if it is not roaming and/or latched onto a Wi-Fi network. In this exemplary embodiment, the gateway 18 can query the presence source 22 to determine that the device 14 is currently roaming and network access is not via Wi-Fi. Accordingly, the gateway 18 can refrain from sending the message to the device 14. In some embodiments, the gateway 18 can send a communication (e.g., an SMS message or other type of communication) to the originating device 11 via the originating network 12 that the device 14 is unable to receive the original MMS message. If, on the other hand, the gateway 18 queries the presence source 22 and determines that the device 14 is not roaming, the gateway 18 can initiate a transfer of the MMS message to the device 14 via the terminating network 16.

It should be appreciated that other combinations of rules and parameters are envisioned. For example, the device 14 can further have an associated rule whereby content is to be rendered according to the type of device 14, such as rendering a website in a resolution appropriate for a tablet if the device 14 is a tablet. Accordingly, the gateway 18 may have to query the transcoding engine 40 in combination with the other engines or sources 19, 20, 22, 30. These parameters and rules can exist independently or in combination with any other parameters or rules associated with the components of the system 10 or otherwise set via the web server or other gateway. Further, the parameters and rules can be layered with priorities. For example, a rule can specify that if a Skype® session cannot be initiated (e.g., due to a business rule), then the transcoding engine 40 should transcode the originating message into a communication that is compatible with Google Talk® session, and the gateway 18 can initiate a Google Talk® session with the device 14. In still further embodiments, the device 14 may not have the capability to accept a certain communication. For example, if the device 14 is a land line telephone, the device 14 may not be able to accept SMS messages. In these cases, the gateway 18 can query the registry 20 to determine a capability of the device 14 and can appropriately continue the transmission if compatible or cease the transmission if not compatible (and optionally send a communication back to the originating device 11 that informs of the lack of compatibility).

In some embodiments, the gateway 18 can introduce a temporal or condition-based aspect to completing a communication transfer. In particular, the rules of the various engines or sources 19, 20, 22, 30, 40 can specify that a certain communication should be fulfilled if or when a condition is met. For example, if the originating device 11 initiates a Facebook® message to the device 14 where the message includes a video, and the rules associated with the device 14 indicate that any multimedia content associated with a Facebook® should be sent only when the device 14 is connected to a Wi-Fi network. Accordingly, the gateway 18 can query the presence source 22 to determine whether the device 14 is connected to a Wi-Fi network. If so, the gateway 18 can initiate the transfer of the message with the video to the device 14. In contrast, if the device 14 is not connected to a Wi-Fi network, the gateway 18 can transmit only the message to the device 14. Further, the gateway 18 can later determine that the device 14 is connected to a Wi-Fi network and can send the video to the device 14 when the device 14 is connected to the Wi-Fi network.

In still further embodiments, the gateway 18 can determine whether an originating communication identifies an active line and/or a well-formed number. In some cases, the originating device 11 can attempt to send an SMS message to a device that is not active. In these cases, the message can be passed along to various networks until it is determined that the destination device is not active. By this time, the various networks may have incurred costs associated with the transmission of the message. In present embodiments, the gateway 18 can query the registry 20 to determine whether (1) the identification of the destination device is well-formed (i.e., is in the correct format or arrangement) and (2) the destination device is active. If either the destination device is not active or the identification of the destination device is not well-formed, the gateway 18 can perform various remedial fixes. In some cases, the gateway 18 can send a communication back to the originating device 11 that informs the originating device 11 that the destination device is not active, in lieu of sending the message to the termination network 16. In other cases, such as if the identification of the destination device is not well-formed, the gateway 18 can perform various corrections (e.g., add a correct international code) to the identification and then transmit the communication to the device 14 via the terminating network 16.

In yet other embodiments, business rules employed by the business rules engine may be driven in whole or in part by contractual relationships or partnerships between carriers, network providers, etc. For example, business rules for a particular carrier or entity may provide preferences or a hierarchal treatment of certain communications depending on the identity of the terminating network. In such a case, one or more particular networks may have preferred status for treatment of the communication. As an additional example, one or more carriers may only send certain types of communications to certain carriers. As yet another example, business rules may incorporate various privacy policies of certain carriers or entities involved.

It should be appreciated that the business rules engine may include rules covering any aspect associated with communications and content delivery in the context of a communications network system, and may take into account without limitation, relationships between entities or carriers, aspects related to specific technology involved, policies and procedures, etc.

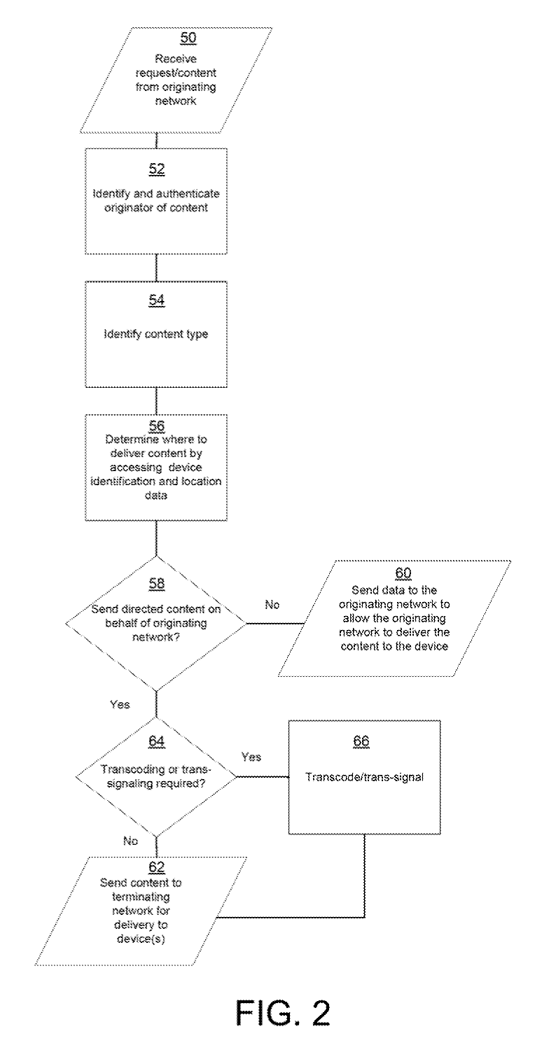

An exemplary and non-limiting embodiment of how the system 10 may be used functionally to facilitate delivery of content from the originating network 12 and the originating device 11 thereof to the device 14 within the terminating network 16 will now be described with general reference to the flow chart in FIG. 2. At step 50, the gateway of the system receives a request from the originating network 12, amongst a plurality of networks associated with the system 10, for processing. It should be noted that, in this example, the request comprises a data header associated with the content. Other embodiments may send a request separate from the content, depending on the desired facilitation. Content type discovery can also be achieved via content signature analysis. At step 52, the gateway 18 first identifies and authenticates the originator of the delivered content. Authentication may be performed by any technique known in the art to ensure subscriber and/or network authenticity, such as, for example a challenge/response algorithm leveraging a random challenge generated by the gateway 18 or a digital signature cryptography on the content, where the content in packet form is simultaneously transmitted with a corresponding digital signature. In the case of digital signature authentication, the digital signature can be cross-checked by the gateway 18 to verify the authenticity of the subscriber and/or the network. The gateway 18 may contain spam and phishing filter capabilities in addition to authentication. Once the content traffic has been authenticated, it is then categorized by type.

At step 54, the content passing through the gateway 18 is identified by type. As noted above, the various types of traffic, including without limitation content, are numerous and may include without limitation: SMS or SMS like messages, MMS messages, Video Call, Video Stream, VoIP voice call, HD VoIP voice call, VoLTE voice call, HD VoLTE voice call, Application Push Notification, and the like. The identification can be accomplished through techniques known in the art, such as, for example, use of content type IDs in the content header.

In this exemplary embodiment, once the content type is identified by the gateway 18, the gateway 18 determines where the content is to be delivered at step 56. The gateway 18 accesses the registry 20 to identify and locate the device to which the content is directed. The registry 20 may be configured to associate the device 14 or devices available to receive the directed content using any of several available data fields. Examples of the data fields available for identifying and locating the device include the mobile identification number (MIN), the IP address, application user name (e.g., Facebook® user name or GoogleTalk® user name), URI and other fields as requested by content providers, carriers and other stakeholders.

Once the device 14 and/or other device(s) is/are identified by the registry 20, the gateway 18 will use industry standard database dips (e.g., NPAC) and RCS Presence capabilities to determine where to deliver the content. As noted above, in some embodiments, the data obtained from these database dips and presence determinations may be stored and continually updated in the registry 20 and associated with the device(s). In such embodiments, the determination of where to deliver the content can be accomplished when the registry 20 is accessed to identify and locate the device(s). In yet other embodiments, both the registry 20 may be checked by the gateway 18 for location/presence data and the gateway 18 will verify this data by conducting the appropriate database dips and presence determinations. Content may be delivered to multiple devices if presence capabilities are not available or the registry 20 indicates the consumer wishes to receive the content on multiple devices. In some embodiments, the registry 20 may also be accessed to determine other data associated with the device, or subscriber or carrier associated with the device, such as for example, preference data or profile data.

When the gateway 18 locates the device 14 and/or other device(s) that is/are to receive the content at step 58, the content either is passed to the respective secure network gateway of the originating network 12 for treatment by the originating network 12 and delivery to the terminating network 16 (step 60), or it is delivered by the gateway 18 to the terminating network 16 within which the device 14 and/or other device(s) is/are present (step 62) with any transcoding and/or trans-signaling requirements determined (step 64) and processed (step 66) prior thereto. In the first instance, the originating network 12 receives the content with header data identifying the content type, authentication and provisioning information. The originating network 12 now has the necessary information to complete the content delivery and to provision the network session as appropriate to ensure network security and quality of service. With this information, the originating network 12 can additionally prioritize the traffic by content type.

In some embodiments, the originating network 12 may send a request to the gateway 18 of the system 10 associated with a requested communications session to obtain data from the system 10 associated with the device(s) involved in the communications session. In such embodiments, the originating network 12 may leverage this data in facilitating establishment of the communications session either directly by the originating network 12, utilizing the system 10 to do so, or utilizing some other network or system. This data may be sent to the originating network 12, the terminating network 16, or one or more intermediate networks, or any combination thereof, to assist network provisioning based on the data, such as, for example, and without limitation, the type of communication session or the type of device(s) involved.

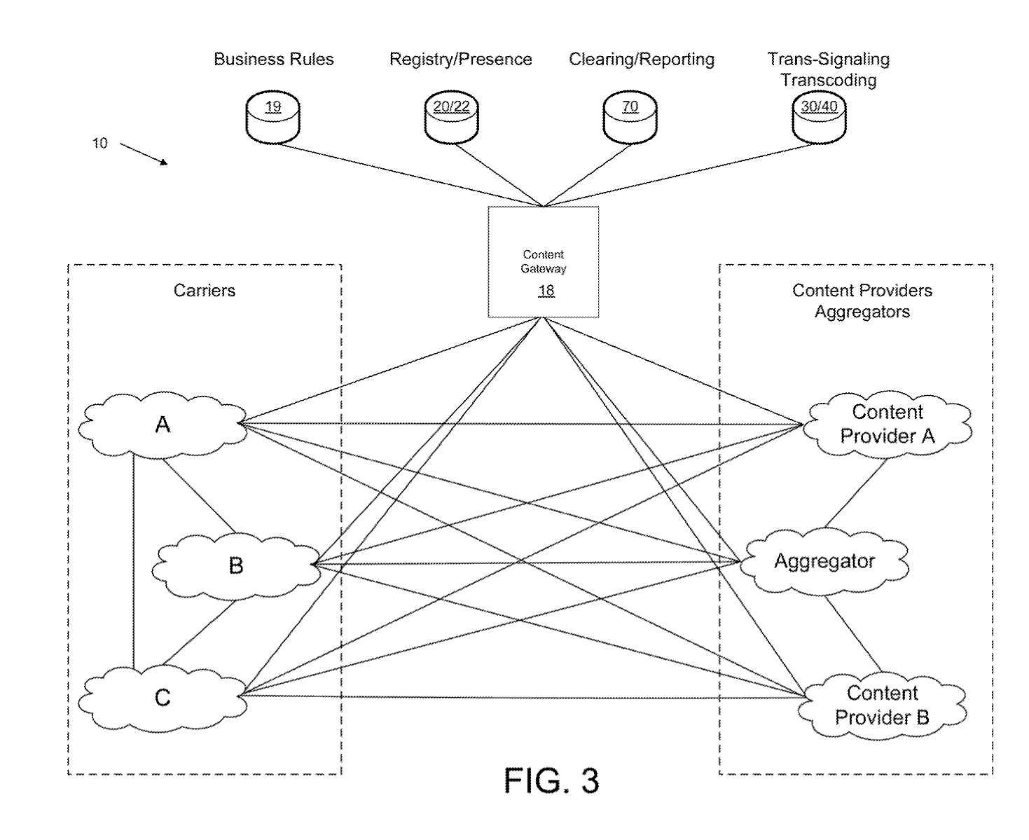

The system 10 may be employed in a broad range of contexts. In an exemplary and non-limiting illustration, FIG. 3 schematically represents the system 10 employed amongst a plurality of networks, including carrier networks A, B and C, content provider networks A and B, and an aggregator network, with the understanding that this illustration is configured for ease and clarity of exemplification, and as such, numerous other configurations are contemplated and numerous other networks and types may be utilizing the system.

As shown in FIG. 3, a plurality of carriers A, B, and C, content providers A and B, and an aggregator are associated with the system 10. This configuration contemplates two separate data paths to reach an end user device. The first is a “direct” connection where the “over the top” data path continues to be accessible. For example, consumers are able to reach any website through a device browser and data is uninterrupted as with traditional wire line Internet access. In this first data path, carriers deliver the data traffic using best efforts. Some device applications may elect to continue to use the first data path, or the “best efforts” environment, in order to reach the device. It is anticipated that carriers may elect to limit data throughput rates in the best efforts environment in order to preserve network integrity and security. The best efforts environment currently represents the low cost, lower quality option for reaching wireless devices. Carriers may elect to prohibit “push” data traffic through the “over the top” data path for security reasons.

As generally illustrated in FIG. 3, the system 10 provides an additional data path to a wireless device. In the system 10 environment, instead of using the “over the top” data path, content is pointed to the gateway of the system 10 for processing. As explained above, the system leverages registry/presence data 20, 22 to determine location/presence of the device. When the gateway 18 locates the device(s) that is/are to receive the content, the content either is passed to the respective secure network gateway of the originating network for treatment by the originating network and delivery to the terminating network, or it is delivered by the gateway to the terminating network within which the device(s) is/are present. In the first instance, the originating network receives the content with header data identifying the content type, authentication and provisioning information. The originating network now has the necessary information to complete the content delivery and to provision the network session as appropriate to ensure network security and quality of service. In some embodiments, the system 10 may send data to the terminating network and/or one or more intermediate networks, for provisioning purposes. In some embodiments, the registry/presence data 20, 22 is obtained by the originating network by sending a request to the system that does not include the content.

Management aspects of the system 10 are also schematically illustrated in FIG. 3. As noted above, the business rules engine 19 provides the ability for customized configuration of how the system 10 processes and treats content traffic and takes into consideration relationships between various networks and carriers. As part of processing content traffic, the gateway 18 can access the business rules engine 19 to apply specific rules attributable to the carrier(s), content provider(s), or other network(s) involved. Clearing and reporting capabilities 70 facilitate financial settlement of content traffic and delivery. In some embodiments, the content traffic delivered through the system 10 will be subject to termination charges paid by the delivering content provider of the originating network to the terminating wireless carrier(s). The clearing and reporting capabilities provide an economic settlement and reporting tool based on traffic passed through the system 10 so that the networks/carriers involved may complete the economic settlement process for their respective content traffic. Carriers can negotiate specific rates for content termination or can rely on default rates established by an industry association. Carriers may elect to accept traffic at no charge, use industry established default termination rates or negotiate specific rates with a specific content provider. In a particular embodiment, all traffic is managed by the system 10 without discrimination regardless of the economic relationship.

In some embodiments, content providers participating in the environment of the system 10 are required to agree to a specific set of business rules regarding the volume, type, frequency and velocity of traffic they send to a wireless subscriber.

As shown in FIG. 3 and as noted above, the system 10 has trans-signaling and transcoding capabilities 30, 40 to address incompatibilities based on the content type or platform. In particular embodiments, the trans-signaling engine 30 is in communication with the gateway 18 and capable of converting a signal type associated with the content to a signal type compatible with the device or client application associated with the device in situations where incompatibility may exist. Similarly, the system may include the transcoding engine 40 in communication with the gateway 18 and capable of converting code associated with the content to make it compatible with the device in situations where incompatibility may exist. The trans-signaling and transcoding engines 30, 40 may employ trans-signaling and transcoding techniques known in the art, which may apply a two-step process in which the original data/file is decoded to an intermediate uncompressed format, which is then encoded into the target format. Other techniques are contemplated as well, such as, for example, techniques that involve directly changing assembled software code to work on a different platform or operating system.

As exemplified in FIG. 3, the plurality of networks may include one or more aggregators. In the context of content traffic, aggregators are service providers that provide messaging services to websites, content providers, or the like. In the current network environment, for example, a large amount of SMS traffic is generated by content providers, such as Google® or Twitter®, and other providers offering SMS-based communication services, such as an airline which may provide flight updates to customers, or other “push” notifications. This type of traffic is often managed and directed on behalf of the content provider by a registry, gateway or other network configuration within a computer network associated with an aggregator, such as Sybase®, Iris®, Syniverse®, or the like. In the aggregator arrangement, SMS traffic generated through content providers is directed to the aggregator, which then transfers the traffic to an appropriate carrier for treatment and delivery of the SMS traffic to one or more intended subscriber devices. As such, the aggregators deal directly with the content providers and the carriers are not directly involved with the service aspects of the transaction. This raises numerous concerns, including disproportionate economic distribution amongst the involved service providers based on actual services provided, decreased network security due to lack of adequate business rules and fraud detection by the content providers and the gateway service providers. From the customer's perspective, this increases risk of fraudulent attacks through aggregator gateways, such as, for example, through SMS spoofing. While the configuration illustrated in FIG. 3 would still permit such practices, preferred implementations of the system 10 would require aggregators to direct all content to the gateway of the system 10 to mitigate or eliminate most of the aforementioned concerns.

Carriers may elect to require all content pushed to wireless devices on their respective networks to be managed through the system 10 or they may elect to retain direct connections to certain trusted carriers and content providers.

The environment of the system 10 is ideally suited to manage many issues facing carriers today. New Long Code SMS messaging capabilities, IP Messaging, Chat applications and yet to be identified content opportunities will require an intermediate environment to authenticate, identify, secure and deliver many types of content. Additionally, current legislative suggestions that dynamic IP addresses for wireless devices be retained by carriers for a specified period of time can be managed by the system 10. Since the registry will continually update the dynamic IP address for each device, this data can be stored within the system 10 and accessed as required, such as, for example, through subpoena in a legal or administrative proceeding, or when required by activities of the Commission on Accreditation for Law Enforcement Agencies, Inc. (CALEA).

The functionality and associated methods of system 10 allows carriers and content providers to select certain elements of the environment for their specific use or to use the environment in its entirety. Larger carriers may have internal capabilities that do not require certain elements of the system 10 environment while a smaller carrier may require the use of all elements and capabilities. Regardless of utilization, the system 10 provides Point of Presence (POP) to connect to other networks.

Among other things, the system 10 will allow consumers to enjoy increased protection from malicious attacks, spam and phishing while enjoying improved quality of service levels from their respective carriers. Carriers will benefit from the increased security as well as the opportunity to participate in the economic benefits associated with premium content delivery. Content providers will benefit from the improved customer experience provided by the carrier and will have the ability to offer new enhanced services through IP Multimedia Subsystem (IMS) services like RCS Presence.

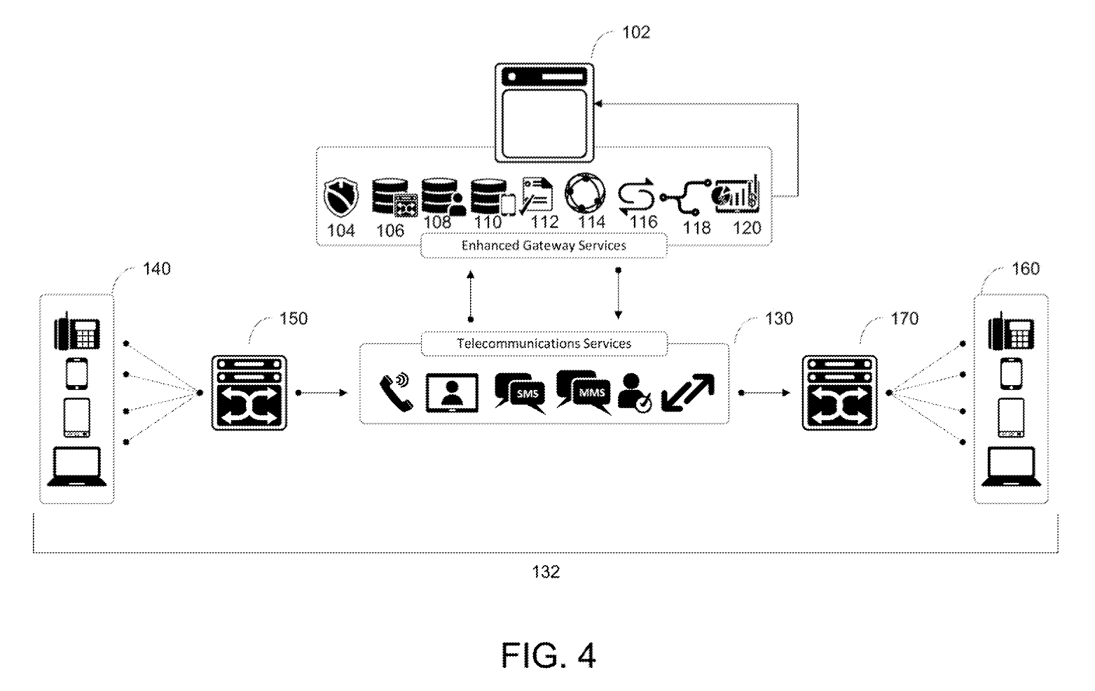

Yet another exemplary and non-limiting illustration of the capabilities and interaction of a system in accordance with one or more principles of the invention(s) is depicted in FIG. 4. FIG. 4 schematically and holistically illustrates the various functionality aspects, and interaction between components, of an exemplary system 100, wherein a gateway 102 and associated registry (the function of which is not separately depicted from the gateway 102) provides a plurality of data, functions and/or service aspects, including 104 (firewall function), 106 (service provider profile), 108 (subscriber profile), 110 (equipment profile), 112 (preferences and profiles), 114 (interconnectivity), 116 (interworking), 118 (routing), and 120 (management functions) as an enhancement to a set of telecommunication services 130 and within a telecommunications framework 132. One or more of the enhanced functions/services can be integrated with or leveraged in connection with communication sessions from one or more of a plurality of devices 140 associated with an originating network 150 to one or more of a plurality of devices 160 associated with a terminating network 170. Devices 140, 160 may include without limitation mobile devices of various types, tablet devices, laptop or desktop PCs or other PC devices, fixed-line telephones/devices, VoIP telephones/devices, OTT Apps, etc. Originating network 150 and terminating network 170 may include one or more networks owned by or associated with one or more telecommunication providers, including without limitation, retail service providers, OTT providers, carriers, operators, intercarrier providers, wholesale carriers, etc. The telecommunications services may include without limitation, TDM voice, VoIP voice, HD voice, VoLTE, VoWi-Fi, IMS voice, video telephony, SMS messaging, MMS messaging, instant messaging, presence, internet data, machine-to-machine data, streaming data, etc.

The firewall function 104 provides firewall and firewall-related functionality to the networks 150, 170, which, among other things, protects the networks from DoS/DDoS attacks, provides network-level policies, provides white lists of e-mail addresses or IP addresses that are considered to be spam free, and other firewall or firewall-related functions in the holistic context of communication sessions or other transmissions between the originating network 150 and the termination network 170. This context provides, among other things, efficiencies to the respective networks.

The service provider profile 106 provides service provider information for a plurality of service providers/networks to facilitate service awareness, prioritization and policy functionality associated with a communications session or transmission based on identification of one or more service providers/networks associated with the session or transmission. For example, based on data associated with a specific service provider profile, certain policies may be applied to treatment of the communications session or transmission. The service provider profile 106 provides this functionality amongst multiple services and providers.

The subscriber profile 108 provides subscriber profile information for a plurality of subscribers across a plurality of networks amongst a plurality of service providers/carriers to facilitate additional functionality. Based on data associated with the subscriber profile, the gateway 102 has a perspective from both the subscriber associated with the device within the originating network and the subscriber associated with the device within the terminating subscriber network. This perspective allows the gateway 102 to leverage the subscriber profiles in connection with treatment of the communications session or transmission. For example, certain subscriber profile information from both the originating and terminating devices may be relevant for certain policy decisions or considerations employed by the gateway 102. The subscriber profile 108 provides the ability to integrate profile information with preference information at the subscriber level. For example, a particular subscriber may set up preferences relating to communication types, device types, temporal constraints, or the like. As one example, a subscriber may designate delivery of content to one particular device during one particular time period and to a second device during a second time period. Such a subscriber may prefer to receive content on a particular mobile device during the lunch hour for example. As additional examples, a particular subscriber may prefer delivery of certain content only if their device is within a WiFi network, or prefer to be sent only links to video content rather than the video itself, or screen shots of the video in a predetermined time interval in order to minimize bandwidth and capacity issues. The functionality facilitated by the subscriber profile provides, among other things, enhanced user experience and operational and cost efficiencies.

The equipment profile 110 provides data associated with equipment or devices to facilitate functionality leveraging such data. For example, this profile allows content providers to render requested content based on the requesting equipment/device type. This profile also allows preferences or other configurations based on equipment/device type for subscriber-to-subscriber interactions.

The preferences and profiles 112 provide data for preference and profile configurations and functionality from a holistic, multi-carrier network environment perspective. Among other things, these preferences and profiles facilitate consolidation and reconciliation of differing policy environments.

The interconnectivity functionality 114 facilitates connectivity between a plurality of originating and terminating networks across multiple services.

The interworking functionality 116 facilitates interoperability between different devices for different services based on application of subscriber device data and subscriber and/or service provider profile data.

The routing functionality 118 facilitates provision of the appropriate end point for a communication session or transmission either directly by the gateway or by providing routing information back to the originating service provider. The routing functionality 118 provides routing based on subscriber profile and/or device type.

The management aspects 120 provide management functionality such as for example the business rules engine, which provides the ability for customized configuration of how the system processes and treats content traffic and takes into consideration relationships between various networks and carriers. Specific rules attributable to the carrier(s), content provider(s), or other network(s) involved can be applied. Clearing and reporting capabilities to facilitate financial settlement of content traffic and delivery are also contemplated.

It should be apparent that the systems and methods described herein can be employed to facilitate or establish an “optimized” communications session or optimized treatment thereof. Such optimization considerations are illustrated by the following example in which a first user is on a first wireless network using a laptop PC and records a video that the first user desires to share with a second user. The second user is on a second network using a feature phone. Accordingly, it would not be efficient to have the first network send the video clip for delivery to the second network when the second device does not support video. In this example, the functionality of the system described herein provides the necessary data and functionality at an appropriate point within the network framework to preclude such inefficiency and cost implications, and rather, provide the opportunity and appropriate functionality to make decisions or facilitate treatment earlier or at more convenient or effective points in the relevant processes.

As an additional example, a first user records an HD video on a first device and wants to send the video to three different users each on a different network. In conventional systems and methods, the video gets sent to all three networks for delivery to each of the users, regardless of device capability or user preferences. In contrast, the subject system gateway can receive the video content and leverage the data and profile associated with the user devices, as well as any policy or profile that may consider, for example, network congestion, peak traffic times, device capabilities, or any other functional/service/data aspect described herein, and send the video based on all of these considerations.

While one or more specific embodiments have been illustrated and described in connection with the invention(s), it is understood that the invention(s) should not be limited to any single embodiment, but rather construed in breadth and scope in accordance with recitation of the appended claims.

What is claimed is:

1. A system for facilitating a communications session between an originating network and a device within a terminating network amongst a plurality of networks, the system comprising:
a gateway capable of communicating with the plurality of networks, including the originating network and the terminating network; and
a registry in communication with the gateway and having access to device data, including identification and location data, for a plurality of devices within the plurality of networks, including the device within the terminating network;
wherein the gateway is configured to receive a request from the originating network, access the registry for the device data for the device, and one of either send data based on at least a portion of the device data to the originating network to allow the originating network to establish the communications session with the device within the terminating network, or establish the communications session with the device within the terminating network on behalf of the originating network.

2. The system of claim 1, wherein the device data comprises capability data for the plurality of devices.

3. The system of claim 1, wherein the device data comprises preference data associated with the plurality of devices.

4. The system of claim 1, wherein the device data comprises preference data associated with a plurality of subscribers each associated with at least one of the plurality of devices.

5. The system of claim 1, wherein the device data comprises preference data associated with a plurality of service providers each associated with at least one of the plurality of devices.

6. The system of claim 1, wherein the registry comprises a set of registries.

7. The system of claim 1, wherein the registry comprises a database service.

8. The system of claim 1, wherein the communication session is of a type selected from the group consisting of an SMS message, an MMS message, a video call, a video stream, a VoIP voice call, an HD VoIP voice call, a VoLTE voice call, an HD VoLTE voice call, presence, and an application push notification.

9. A system for facilitating delivery of content from an originating network to a device within a terminating network amongst a plurality of networks, the system comprising:
a gateway capable of communicating with the plurality of networks, including the originating network and the terminating network; and
a registry in communication with the gateway and having access to device data, including identification and location data, for a plurality of devices within the plurality of networks, including the device within the terminating network;
wherein the gateway is configured to receive a request associated with the content from the originating network, access the registry for at least a portion of the device data for the device, and either send data based on at least the portion of the device data to the originating network to allow the originating network to either deliver the content to the terminating network or otherwise treat the content within the originating network, or deliver the content to the terminating network on behalf of the originating network.

10. The system of claim 9, wherein the device data comprises capability data for the plurality of devices.

11. The system of claim 9, wherein the device data comprises preference data associated with the plurality of devices.

12. The system of claim 9, wherein the device data comprises preference data associated with a plurality of subscribers each associated with at least one of the plurality of devices.

13. The system of claim 9, wherein the device data comprises preference data associated with a plurality of service providers each associated with at least one of the plurality of devices.

14. The system of claim 9, wherein the registry comprises a set of registries.

15. The system of claim 9, wherein the registry comprises a database service.

16. The system of claim 9, wherein the communication session is of a type selected from the group consisting of an SMS message, an MMS message, a video call, a video stream, a VoIP voice call, an HD VoIP voice call, a VoLTE voice call, an HD VoLTE voice call, presence, and an application push notification.

17. The system of claim 9, wherein the request comprises a data header appended to the content.

18. The system of claim 9, wherein the request is separate from the content.

19. A system for facilitating a communications session between a device within an originating network and a device within a terminating network amongst a plurality of networks, the system comprising:
a gateway capable of communicating with the plurality of networks, including the originating network and the terminating network;
a registry in communication with the gateway and having access to device data, including identification and location data, for a plurality of devices within the plurality of networks, including the device within the originating network and the device within the terminating network;
wherein the gateway is configured to receive a request for a communications session from the originating network, access the registry for device data, and one of:
send data based on at least a portion of the device data to the originating network to allow the originating network to either establish the communications session with the device or otherwise treat the request for the communications session within the terminating network;
establish the communications session with the device within the terminating network; or
treat the request for the communications session on behalf of the originating network.

20. The system of claim 19, wherein the device data comprises capability data for the plurality of devices.

21. The system of claim 19, wherein the device data comprises preference data associated with the plurality of devices.

22. The system of claim 19, wherein the device data comprises preference data associated with a plurality of subscribers each associated with at least one of the plurality of devices.

23. The system of claim 19, wherein the device data comprises preference data associated with a plurality of service providers each associated with at least one of the plurality of devices.

24. The system of claim 19, wherein the registry comprises a set of registries.

25. The system of claim 19, wherein the registry comprises a database service.

26. The system of claim 19, wherein at least a portion of the device data is stored within the registry and is continually updated.

27. The system of claim 19, wherein the communication session is of a type selected from the group consisting of an SMS message, an MMS message, a video call, a video stream, a VoIP voice call, an HD VoIP voice call, a VoLTE voice call, an HD VoLTE voice call, presence, and an application push notification.

28. The system of claim 19, wherein the data sent to the originating network includes preference data associated with the device within the terminating network.

29. The system of claim 19, further comprising a trans-signaling engine in communication with the gateway and capable of converting a signal type associated with the communications session to a signal type compatible with the device within the terminating network.

30. The system of claim 19, further comprising a transcoding engine in communication with the gateway and capable of converting code associated with the communications session to make it compatible with capabilities of the device within the terminating network.

31. The system of claim 19, further comprising a business rules module in communication with the gateway having access to business rules data associated with each of the plurality of networks, and applies business rules in treating the request for the communications session between the originating network and the terminating network if business rules data exists for one or both of the originating network and the terminating network.

32. The system of claim 31, wherein the business rules module provides economic clearing and settlement between the originating network and the terminating network for the communications session.
